(19) United States
(12) Patent Application Publication
(10) Pub. No.: US 2020/0098049 A1
(43) Pub. Date: Mar. 26, 2020

(54) SECURING A VEHICLE ON OWNER CHANGE

(71) Applicant: FORD GLOBAL TECHNOLOGIES, LLC, Dearborn, MI (US)

(72) Inventors: Arthur Van JACK, Southfield, MI (US); Kwaku O. PRAKAH-ASANTE, Commerce Township, MI (US); Karl Nathan CLARK, Belleville, MI (US); Tracy S. PARKS, Commerce Township, MI (US)

(21) Appl. No.: 16/138,639

(22) Filed: Sep. 21, 2018

(51) Int. Cl. G06Q 40/08; G07C 5/00; G06F 21/62

(52) U.S. Cl. CPC G06Q 40/08; G06F 2221/2143; G06F 21/6245; G07C 5/008

(57) ABSTRACT

An insurance server is programmed to terminate sharing of personal data from a vehicle for use in usage-based insurance responsive to a policy termination for the vehicle, send a request to the subscription server to cause the vehicle to purge vehicle memory of personal data, and responsive to confirmation from the subscription server, inform a seller of the vehicle of termination of sharing and storage of the personal data.

### TECHNICAL FIELD

Aspects of the disclosure generally relate to securing a vehicle on a change of ownership of the vehicle.

### BACKGROUND

When a user purchases a vehicle, the user may purchase vehicle insurance. Additionally, the user may set up an account through which the insurance company may receive information from the vehicle relating to the user's driving style. This information may be used by the insurance company to refine the rate that is charged to the user to insure the vehicle.

A strategic approach for competitiveness for vehicle sales includes improving customer convenience and awareness through connectivity. Many vehicles are being actively equipped with modems to enable connectivity features. By 2020, a significant amount of vehicles will be connected. The focus on improving the user-centric experience during a ride promotes methods and means for personalization and security. In situations where connected vehicles are lent or sold, those vehicles may still store private data of another user.

### SUMMARY

In one or more illustrative embodiments, a system includes a subscription server; and an insurance server programmed to terminate sharing of personal data from a vehicle for use in usage-based insurance responsive to a policy termination for the vehicle, send a request to the subscription server to cause the vehicle to purge vehicle memory of personal data, and responsive to confirmation from the subscription server, inform a user of the vehicle of termination of sharing and storage of the personal data.

In one or more illustrative embodiments, a method includes, responsive to a policy termination for a vehicle due to the vehicle being purchased by a buyer from a seller, terminating sharing of personal data of the seller from a vehicle for use in usage-based insurance, purging the vehicle of the personal data, sending a message to the seller confirming the purging, and sending a message to the buyer offering usage-based insurance to the buyer.

In one or more illustrative embodiments, a method includes responsive to receipt of an alert from a likelihood observer system monitoring driving performance, vehicle route and location behavior, and interior driver situations, that a current user of the vehicle is no longer operating the vehicle, temporarily terminate sharing of personal data from the vehicle; and responsive to conclusion of the alert, reestablish sharing of personal data from the vehicle.

### BRIEF DESCRIPTION OF THE DRAWINGS

FIG. 1 illustrates an example diagram of a system configured to secure personal data on a change in vehicle ownership;

FIG. 2 illustrates an example process for initiating automatic purging of on-board and off-board personal data;

FIG. 3 illustrates an example process for informing a seller of the vehicle of the automatic purging;

FIG. 4 illustrates an example process for informing a buyer of the vehicle of the automatic purging;

FIG. 5 illustrates an example system for prior digital information availability avoidance for enhanced connected vehicle security; and

FIG. 6 illustrates an example process for operation of the prior digital information availability service.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

With the proliferation of vehicles having embedded modems and cloud connectivity, privacy and data security have become more important issues to address with respect to vehicle sales. In a private sale transaction, it is up to the seller to perform a factory reset to remove all personal settings and data that may be stored on the vehicle. As for personal information stored to the cloud, it may be difficult for the seller of the vehicle to remove off-board data stored in the cloud that is associated with the seller. Thus, with ownership transfers, it may be difficult to automatically and confidently purge on-board and associated off-board privacy and usage data information.

An event-based solution may be utilized that performs data purging according to an update or change to a vehicle's insurance policy as recorded and reported by an insurance company. Under Usage-Based Insurance (UBI) agreements, owners typically opt-in to allow data acquisition from either a plug-in device (e.g., an on-board-diagnostics dongle) or an embedded modem. The opt-in process is incentivized with lower insurance premiums being available if the user opts in.

During the policy creation process, agents enter vehicle information such as make/model, VIN, and vehicle condition (sometimes with photographs of the vehicle) into the system. Based on the policy, insurance premium payments occur monthly, semi-annually or annually to maintain an active account with linkage to the owner. The interval cadence will be associated with the customer's account and vehicle that can be accessed through UBI insurance partnerships.

Responsive to pre-defined policy changes that occur due to ownership transfer and policy termination, the insurance company policy updates stored on a server may be configured to inform a subscription server managing the vehicle of the change in insurance. These policy changes may include, for example, actions by a seller of the vehicle such as cancellation of the policy by the seller, or actions by a buyer of the vehicle such as initiation of a request for a new policy by the buyer. Responsive to receipt of the indication, the subscription server may be configured to send a factory reset message to the vehicle as well as disassociate any cloud-based information of the seller from the vehicle. Confirmation of these deactivation notifications may be sent to the seller and buyer of the vehicle. The buyer notification may further include an option to contact the insurance company for a quote. Further aspects of the disclosure are discussed in detail herein.

In addition to vehicle sales, there may be temporary privacy issues if a user lends the vehicle to a user not in the immediate group of frequent users, where the original user may still have digital access to the vehicle. A prior digital information availability system may be utilized to enhanced connected vehicle security in such situations as well.

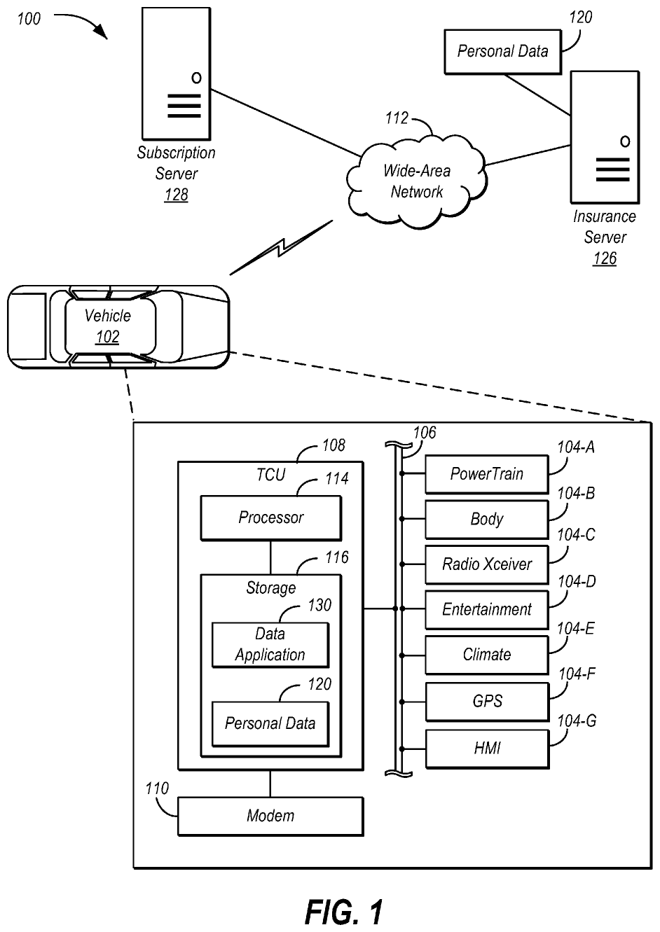

FIG. 1 illustrates an example system 100 configured to secure personal data 120 on a change in ownership of a vehicle 102. As illustrated, the vehicle 102 includes a plurality of electronic controllers 104 in communication over one or more vehicle buses 106. The system 100 also includes an insurance server 126 configured to maintain personal data 120 received from various vehicles 102, as well as a subscription server 128 configured to manage accounts of users of the vehicles 102. The vehicle 102 further includes a Telematics Control Unit (TCU) 108 configured to send personal data 120, including information useful for adjusting insurance rates, to the insurance server 126. The TCU 108 may utilize a data application 130 installed to the TCU 108 to send a cadence of personal data 120 to the insurance server 126. It should be noted that the system 100 is merely an example, and other arrangements or combinations of elements may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as VINs.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104-A through 104-G. However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104-A may be configured to provide control of engine operating components (e.g., idle control components, fuel delivery components, emissions control components, etc.) and for monitoring status of such engine operating components (e.g., status of engine codes); a body controller 104-B may be configured to manage various power control functions such as exterior lighting, interior lighting, keyless entry, remote start, and point of access status verification (e.g., closure status of the hood, doors and/or trunk of the vehicle 102); a radio transceiver controller 104-C may be configured to communicate with key fobs, mobile devices, or other local vehicle 102 devices; an entertainment controller 104-D may be configured to support voice command and BLUETOOTH interfaces with the driver and driver carry-on devices; a climate control management controller 104-E may be configured to provide control of heating and cooling system components (e.g., compressor clutch, blower fan, temperature sensors, etc.); a Global Positioning System (GPS) controller 104-F may be configured to provide vehicle location information; and a Human Machine Interface (HMI) controller 104-G may be configured to receive user input via various buttons or other controls, as well as provide vehicle status information to a driver, such as fuel level information, engine operating temperature information, and current location of the vehicle 102.

The vehicle bus 106 may include various methods of communication available between the controllers 104, as well as between the TCU 108 and the vehicle controllers 104. As some non-limiting examples, the vehicle bus 106 may include one or more of a vehicle Controller Area Network (CAN), an Ethernet network, and a Media-Oriented System Transfer (MOST) network. Further aspects of the layout and number of vehicle buses 106 are discussed in further detail below.

The TCU 108 may include network hardware configured to facilitate communication between the vehicle controllers 104 and other devices of the system 100. For example, the TCU 108 may include or otherwise access a cellular modem 110 configured to facilitate communication with a wide-area network 112. The wide-area network 112 may include one or more interconnected communication networks such as the Internet, a cable television distribution network, a satellite link network, a local area network, and a telephone network, as some non-limiting examples. As another example, the TCU 108 may utilize one or more of BLUETOOTH, Wi-Fi, or wired USB network connectivity to facilitate communication with the wide-area network 112 via the user's mobile device.

The TCU 108 may further include various types of computing apparatus in support of performance of the functions of the TCU 108 described herein. In an example, the TCU 108 may include one or more processors 114 configured to execute computer instructions, and a storage 116 medium on which the computer-executable instructions and/or data may be maintained. A computer-readable storage medium (also referred to as a processor-readable medium or storage 116) includes any non-transitory (e.g., tangible) medium that participates in providing data (e.g., instructions) that may be read by a computer (e.g., by the processor(s)). In general, the processor 114 receives instructions and/or data, e.g., from the storage 116, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, JAVA, C, C++, C #, FORTRAN, PASCAL, VISUAL BASIC, PYTHON, JAVA SCRIPT, PERL, PL/SQL, etc.

The TCU 108 may be configured to include one or more interfaces from which vehicle information may be sent and received. In an example, the TCU 108 may be configured to facilitate the collection of user-identifying information and/or other vehicle information from the vehicle controllers 104 connected to the one or more vehicle buses 106. This collected information may be referred to as personal data 120. The TCU 108 may store the collected personal data 120 to the storage 116 of the TCU 108 or, in other examples, to other storage in communication with the TCU 108. The vehicle information retrieved by the TCU 108 may include, as some non-limiting examples, accelerator pedal position, steering wheel angle, vehicle speed, vehicle location (e.g., GPS coordinates, etc.), vehicle unique identifier (e.g., VIN), engine revolutions per minute (RPM), and vehicle HMI information, such as steering wheel button press information. Thus, personal data 120 may include user-identifying information as well as other vehicle information stored to the storage 116 of the TCU 108.

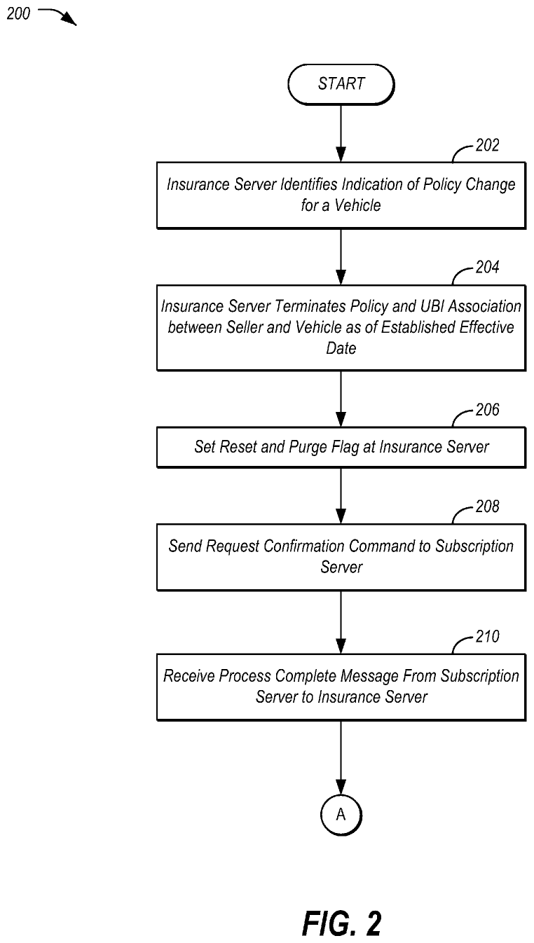

The insurance server 126 and the subscription server 128 may each include various types of computing apparatus, such as a computer workstation, a server, a desktop computer, a virtual server instance executed by a mainframe server, or some other computing system and/or device. Similar to the TCU 108, the insurance server 126 and the subscription server 128 generally include a memory on which computer-executable instructions may be maintained, where the instructions may be executable by one or more processors (not shown for clarity). Such instructions and other data may be stored using a variety of computer-readable media. Further aspects of the operation of these servers are described in detail below with respect to FIGS. 2-4.

The data application 130 may be one application included on the storage 116 of the TCU 108. The data application 130 may include instructions that, when executed by the processor 114 of the TCU 108, cause the TCU 108 to periodically or otherwise collect the personal data 120 information from the controllers 104, store the information for transmission, and transmit the personal data 120 to the insurance server 126 over the wide-area network 112. The data application 130 may also include instructions for performing functions in response to receipt of messages received from the subscription server 128.

FIG. 2 illustrates an example process 200 for initiating automatic purging of on-board and off-board personal data 120. In an example, the process 200 may be performed by the insurance server 126 in the context of the system 100.

At operation 202, the insurance server 126 receives an indication of a policy change for a vehicle 102. In an example, the insurance server 126 may identify from a seller that a policy change for a vehicle 102 has occurred due to an ownership transfer and policy termination by the seller for the vehicle 102. As another example, the insurance server 126 may additionally or alternately receive an indication from a buyer of a policy change for a vehicle 102, such as a request by the buyer to insure the vehicle 102. At 204, the insurance server 126 terminates the insurance policy and UBI association of the seller for the vehicle 102 as of an effective date. In an example, this termination may be performed in accordance with the policy change identified at operation 202.

At 206, the insurance server 126 sets a reset and purge flag at the insurance server 126. This flag may indicate that the insurance policy for the vehicle 102 is in a state of being terminated, and therefore that personal data 120 related to the insurance policy should be automatically cleared.

At 208, the insurance server 126 sends a termination command to the subscription server 128. This request confirmation message may be sent by the insurance server 126 responsive to the setting of the reset and purge flag. The subscription server 128, responsive to receipt of the termination command, sends a message to the vehicle 102 to cause the vehicle 102 to purge itself of personal data 120. For instance, the data application 130 of the vehicle 102 may receive the purge message from the subscription server 128 and may delete any personal data 120 from the vehicle 102 in response.

At 210, the insurance server 126 receives a process complete message from the subscription server 128. In an example, the insurance server 126 receives the process complete message from the subscription server 128 responsive to the subscription server 128 requesting for the vehicle 102 to purge data, or responsive to receiving a confirmation from that vehicle 102 that the data was purged.

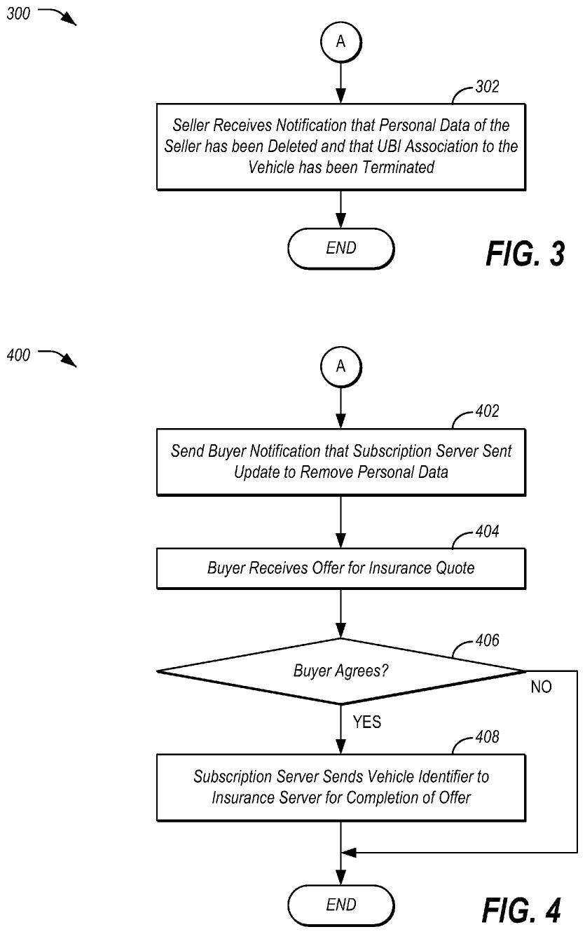

FIG. 3 illustrates an example process 300 for informing a seller of the vehicle 102 of the automatic purging. In an example, the process 300 may be initiated responsive to completion of operation 210 of the process 200.

At operation 302, the insurance server 126 notifies the seller that the personal data 120 of the seller has been deleted and that the UBI association of the vehicle 102 to the insurance server 126 has been terminated. In an example, the insurance server 126 may send an SMS message or other types of message to a mobile device of the seller. Accordingly, upon receipt of the message, the seller may be informed that his or her data has remained safe. After operation 302, the process 300 ends.

FIG. 4 illustrates an example process 400 for informing a buyer of the vehicle 102 of the automatic purging. In an example, the process 400 may be initiated responsive to the message sent to the subscription server 128 at operation 208 of the process 200.

At operation 402, the subscription server 128 sends the buyer of the vehicle 102 a notification that the subscription server 128 updated the vehicle 102 to remove personal data 120 from the vehicle 102 and the insurance server 126. In an example, the subscription server 128 may send an SMS message or other types of message to a mobile device of the buyer. Accordingly, upon receipt of the message, the buyer may be informed that the vehicle 102 is free of data of the buyer.

At 404, the subscription server 128 optionally sends the buyer contact information or for the insurance server 126 along with an invitation for the buyer to contact the insurance server 126 to obtain an insurance quote for the vehicle 102. In an example, the subscription server 128 may include the invitation in the SMS sent at operation 402.

At operation 406, the subscription server 128 determines whether the buyer accepts the offer to obtain a quote. In an example, the message to the buyer may indicate that the buyer can respond to the message to accept the offer. For instance, the buyer could SMS message back “Yes” or “Y” or another predefined response to accept the offer. If the offer is accepted, control passes to operation 408. Otherwise, the process 400 ends.

At 408, the subscription server 128 sends an identifier of the vehicle 102 and information regarding the buyer to the insurance server 126 to allow the insurance server 126 to complete the quoting process. After operation 408, the process 400 ends.

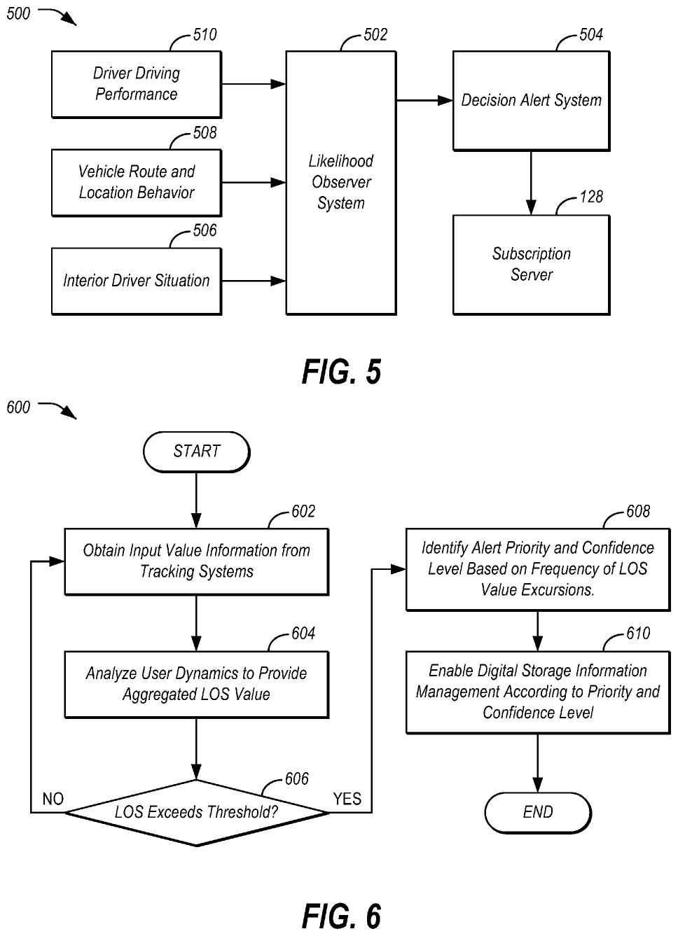

FIG. 5 illustrates an example system for Prior Digital Information Availability (PDIA) 500 avoidance for enhanced connected vehicle 102 security. The PDIA 500 may be configured to manage digital information of the prior frequent users stored in the vehicle 102. The PDIA 500 determines the vehicle 102 usage conditions and driver interior conditions, and determines the likelihood of a new user in the vehicle 102 or other significant operational changes. If opted for, the likelihood is sent to the subscription server 128 or other remote server as a reminder to inform stakeholders, or to automatically reset the digital storage information.

A system and method that incorporates a Likelihood Observer System (LOS) 502 may predict a likelihood of a significant usage conditional change for digital availability avoidance (e.g., the availability of personal data 120). The system and method may incorporate vehicle usage conditions, vehicle interior conditions, and driving performance to perform smart decision making. Additionally, the system and method may provide an added layer of security for customers or other users of the vehicle 102.

Referring more specifically to FIG. 5, the PDIA 500 may include the LOS 502 and a Decision Alert System (DAS) 504. The LOS 502 may be configured to compute an aggregated LOS value indicator for evaluation by the DAS 504. The LOS 502 may provide a weighted composition of inconsistent behavior obtained from, an Interior Driver Situation component 506, a Vehicle Route and Location Behavior component 508, and a Driver Driving Performance component 510. While an exemplary modularization of the PDIA 500 is described herein, it should also be noted that elements of the PDIA 500 may be incorporated into fewer units or may be combined in several units or even in one unit. In one example, the operation of the PDIA 500 may be performed by an application executed by the TCU 108, such as the data application 130.

The input components 506, 508, and 510 may each provide, in an example, a value between 0-1 as a determinant of a deviation from a prior established norm. For instance, for the Interior Driver Situation component 506, the deviation may be from interior preferences or interior image recognition. For the Vehicle Route and Location Behavior component 508, the component 508 may track potential new geographical usage of the vehicle 102. The Driver Driving Performance component 510 may identify driving style changes from a sub-set of drivers who often use the vehicle 102. Further aspects of the operation of the input components 506, 508, and 510 are discussed in detail in the following commonly-owned patent applications, U.S. Pat. No. 9,707,974 titled “Vehicle with identification system,” U.S. Pat. No. 8,258,934 titled “Vehicle and method of advising a driver therein,” and U.S. Pat. No. 9,789,788 titled “Method and apparatus for primary driver verification” each of which is incorporated herein by reference in its entirety.

The LOS value may be given by the equation (1):

LOSᵥₐₗ=Σᵢ₌₁^{N}wᵢyᵢ (1)

where:
LOSᵥₐₗ is the Likelihood Observer System aggregated value;
N is the number of inconsistent activity indicators tracked;
yᵢ is a leading inconsistent activity indicator; and
wᵢ is the weight attributed to each anomaly indicator being tracked.

For example, for N=2, with leading activity indicators (DDPᵥₐₗ and IDSᵥₐₗ), the LOSᵥₐₗ may be computed as follows:

LOSᵥₐₗ=DDPᵥₐₗ×w1+IDSᵥₐₗ×w2 (2)

where:
DDPᵥₐₗ is a continuous value that indicates driver performance style changes;
IDSᵥₐₗ is a continuous value to track interior vehicle changes;
w₁ is a tunable weight attributed to DDPval; and
w₂ is a tunable weight attributed to IDSval.

The LOSᵥₐₗ, as computed, may be presented to the DAS 504. The DAS 504 may accordingly receive the LOSᵥₐₗ, and evaluate to identify whether the LOSᵥₐₗ exceeds a predefined threshold value. If so, the DAS 504 may indicate an alert condition. In an example, the alert may be sent to the subscription server 128. Once received, the alert may be used as a reminder to inform stakeholders, or to automatically reset the digital storage information, or preclude digital availability access. For instance, the alert may temporarily prevent the instance server 126 from having access to the personal data 120 of the vehicle 102 until the alert condition no longer exists.

FIG. 6 illustrates an example process 600 for operation of the PDIA. In an example, the process 600 may be performed by the data application 130 being executed by the TCU 108 of the vehicle 102.

At 602, the vehicle 102 obtains input value information from one or more tracking systems.

At 604, the vehicle 102 analyze user dynamics to provide an aggregated LOSᵥₐₗ. In an example, the vehicle 102 utilizes the LOS 502 of the PDIA 500 to receive the input value information and compute the LOSᵥₐₗ. Example computations are discussed in detail above with regard to equations (1) and (2).

At 606, the vehicle 102 determines whether the LOSᵥₐₗ exceeds a predefined threshold. In an example, the DAS 504 receives the LOSᵥₐₗ from the LOS 502, and compares the LOSᵥₐₗ to the predefined threshold that when exceeded, causes an alert to be raised. The alert may indicate a probability that the driver of the vehicle 102 has changed.

At 608, the vehicle 102 identifies an alert priority and a confidence level of the alert priority based on a frequency of the LOSᵥₐₗ excursions beyond the predefined threshold. In an example, the DAS 504 determines whether the amount of probable excursions is such that privacy data 120 protections should be engaged. If so, at 610, the vehicle 102 sends an alert message to enable digital storage information management according to the alert priority and a confidence level. For instance, the subscription server 128 may receive the alert, and may deny access to privacy data 120 of the vehicle 102 to the insurance server 126 until the alert condition is concluded.

Computing devices described herein, such as the TCU 108, insurance server 126, and subscription server 128, generally include computer-executable instructions where the instructions may be executable by one or more computing devices such as those listed above. Computer-executable instructions, such as those of the data application 130, may be compiled or interpreted from computer programs created using a variety of programming languages and/or technologies, including, without limitation, and either alone or in combination, JAVA™, C, C++, C #, VISUAL BASIC, JAVASCRIPT, PYTHON, JAVASCRIPT, PERL, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a subscription server; and
an insurance server programmed to
terminate sharing of personal data from a vehicle for use in usage-based insurance responsive to a policy termination for the vehicle,
send a request to the subscription server to cause the vehicle to purge vehicle memory of personal data, and
responsive to confirmation from the subscription server, inform a user of the vehicle of termination of sharing and storage of the personal data.

2. The system of claim 1, wherein the insurance server is further programmed to identify the policy termination for the vehicle responsive to an indication of a transfer of the vehicle from the user to a new user.

3. The system of claim 1, wherein the subscription server is programmed to send a notification to a new user of the vehicle that the subscription server directed the vehicle to purge vehicle memory of the personal data.

4. The system of claim 3, wherein the subscription server is further programmed to include an offer for an insurance quote for the new user in the notification to the new user.

5. The system of claim 3, wherein the new user is a buyer of the vehicle and the user is a seller of the vehicle.

6. The system of claim 3, wherein the notification to the new user is a Short Message Service (SMS) message.

7. The system of claim 3, wherein the subscription server is further programmed to offer, in the notification, that the insurance server provides an insurance quote to the new user for the vehicle.

8. The system of claim 7, wherein the subscription server is further programmed to receive, in response to the notification, a response that the new user agrees to receive the insurance quote.

9. The system of claim 8, wherein the response is an SMS message.

10. The system of claim 1, wherein the personal data includes user-identifying information as well as other vehicle information received from vehicle controllers.

11. A method comprising:
responsive to a policy termination for a vehicle due to the vehicle being purchased by a buyer from a seller, terminating sharing of personal data of the seller from a vehicle for use in usage-based insurance, purging the vehicle of the personal data, sending a message to the seller confirming the purging, and sending a message to the buyer offering usage-based insurance to the buyer.

12. The method of claim 11, further comprising:
responsive to receipt of an alert from a likelihood observer system monitoring driving performance, vehicle route and location behavior, and interior driver situations, temporarily terminate sharing of personal data from the vehicle.

13. The method of claim 11, further comprising receiving, in response to the message to the buyer, a response that the buyer agrees to receive a quote for the insurance.

14. The method of claim 11, wherein the message to the seller and the message to the buyer are sent via Short Message Service (SMS).

15. The method of claim 11, further comprising sending a message to the vehicle requesting the purging of personal data, receiving a response from the vehicle confirming the purging.

16. The method of claim 15, further comprising sending the message to the seller and sending the message to the buyer, both responsive to receipt of the response from the vehicle confirming the purging.

17. The method of claim 11, wherein the personal data includes user-identifying information as well as other vehicle information received from vehicle controllers.

18. A method comprising:
responsive to receipt of an alert from a likelihood observer system monitoring driving performance, vehicle route and location behavior, and interior driver situations, that a current user of the vehicle is no longer operating the vehicle, temporarily terminate sharing of personal data from the vehicle; and
responsive to conclusion of the alert, reestablish sharing of personal data from the vehicle.

19. The method of claim 18, further comprising, responsive to a policy termination for the vehicle for a current user, terminate sharing of personal data of the current user from a vehicle for use in usage-based insurance, purge the vehicle of the personal data, send a message to current user confirming the purging, and send a message to a new user offering usage-based insurance to the new user.

20. The method of claim 19, further comprising:
sending a message to the vehicle requesting the purging of personal data;
receiving a response from the vehicle confirming the purging; and
sending the message to the current user and sending the message to the new user responsive to receipt of the response from the vehicle confirming the purging.
